(19) United States
(12) Patent Application Publication
(10) Pub. No.: US 2025/0175985 A1
(43) Pub. Date: May 29, 2025

(54) DYNAMIC WAVEFORM SWITCHING FOR MSG3 PUSCH

(71) Applicant: QUALCOMM Incorporated, San Diego, CA (US)

(72) Inventors: Hung Dinh LY, San Diego, CA (US); Kexin XIAO, Shanghai (CN); Gokul SRIDHARAN, Sunnyvale, CA (US)

(21) Appl. No.: 18/715,691

(22) PCT Filed: Feb. 23, 2022
(86) PCT No.: PCT/CN2022/077392

§ 371 Date: May 31, 2024

(51) Int. Cl. H04W 72/21; H04B 7/06; H04W 74/0833

(52) U.S. Cl. CPC H04W 72/21; H04B 7/0626; H04W 74/0833

(57) ABSTRACT

A base station and a user equipment (UE) may be configured to perform a dynamic waveform switching for a third random access message (Msg3) physical uplink shared channel (PUSCH) transmission during an initial access procedure. The base station may transmit a second random access message (Msg2) including an indication of a waveform for the Msg3 PUSCH transmission. The UE may receive the Msg2 including indication of the waveform for the Msg3 PUSCH transmission, and the UE may perform a dynamic waveform switching in response to the received indication of the waveform for the Msg3 PUSCH transmission by transmitting the Msg3 PUSCH based on the indication of the waveform received from the base station.

### TECHNICAL FIELD

The present disclosure relates generally to communication systems, and more particularly, to a method of wireless communication for providing a dynamic waveform switching for a random access.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a base station and a user equipment (UE) configured to perform a dynamic waveform switching for a third random access message (Msg3) physical uplink shared channel (PUSCH) transmission during an initial access procedure. The base station may transmit a second random access message (Msg2) including an indication of a waveform for the Msg3 PUSCH transmission. The UE may receive the Msg2 including indication of the waveform for the Msg3 PUSCH transmission, and the UE may perform a dynamic waveform switching in response to the received indication of the waveform for the Msg3 PUSCH transmission by transmitting the Msg3 PUSCH based on the indication of the waveform received from the base station.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4A is a type-1 random access channel (RACH) procedure of a method of wireless communication.

FIG. 4B illustrates various transmissions of the Msg3 PUSCH of a method of wireless communication.

FIG. 5 illustrates example content of a medium access control (MAC) random access response (RAR) that may be used to indicate the dynamic waveform configuration of a method of wireless communication.

FIG. 6 is a call-flow diagram of a method of wireless communication.

FIG. 7 is a flowchart of a method of wireless communication.

FIG. 8 is a flowchart of a method of wireless communication.

FIG. 9 is a flowchart of a method of wireless communication.

FIG. 10 is a flowchart of a method of wireless communication.

FIG. 11 is a diagram illustrating an example of a hardware implementation for an example apparatus and/or network entity.

### DETAILED DESCRIPTION

During an initial access procedure, the waveform for a third random access message (Msg3) physical uplink shared channel (PUSCH) transmission may be configured by a random access channel (RACH) configuration, which is cell-specific. In some aspects of the current disclosure, the network including a base station and a user equipment (UE) may be configured to perform a dynamic waveform switching for the Msg3 PUSCH transmission during the initial access procedure. The dynamic waveform switching may improve the coverage of the Msg3 PUSCH.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

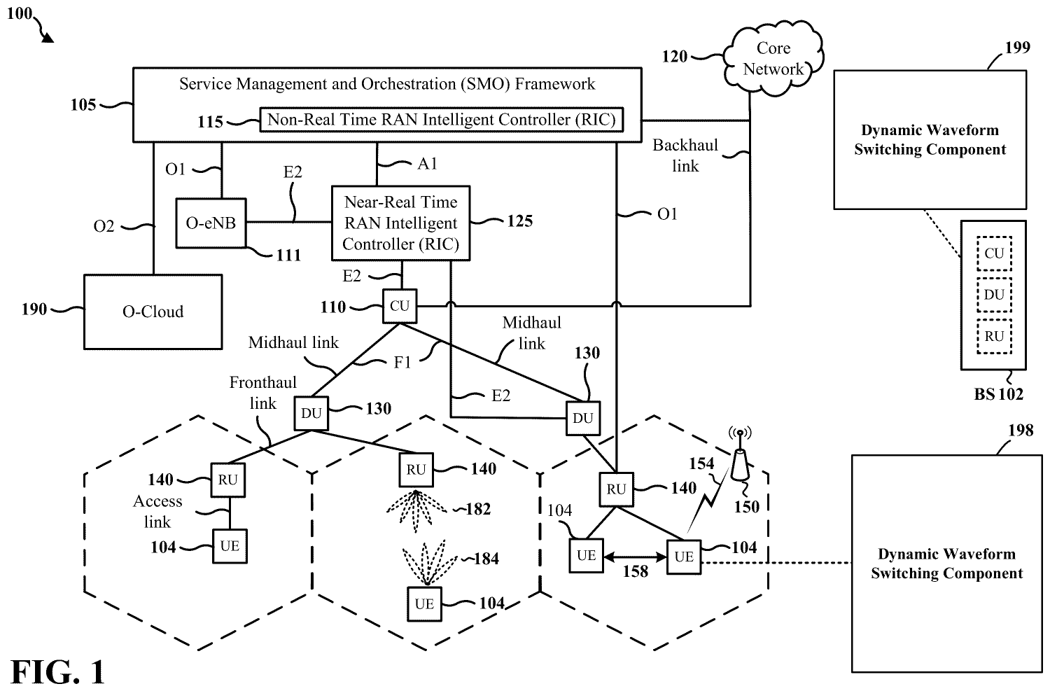

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an El interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an AI interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as AI policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a dynamic waveform switching component 198 configured to transmit, to a base station, a Msg1, receive, from the base station, an indication of a waveform of a Msg3 PUSCH, and transmit, to the base station, the Msg3 PUSCH using the waveform indicated by the base station. In certain aspects, the base station 102 may include a dynamic waveform switching component 199 configured to receive a Msg1, output for transmission, for a UE, an indication of a waveform of a Msg3 PUSCH, and receive the Msg3 PUSCH using the waveform indicated to the UE. Although the following description may be focused on 5G NR, the concepts described herein may be applicable to other similar areas, such as LTE, LTE-A, CDMA, GSM, and other wireless technologies.

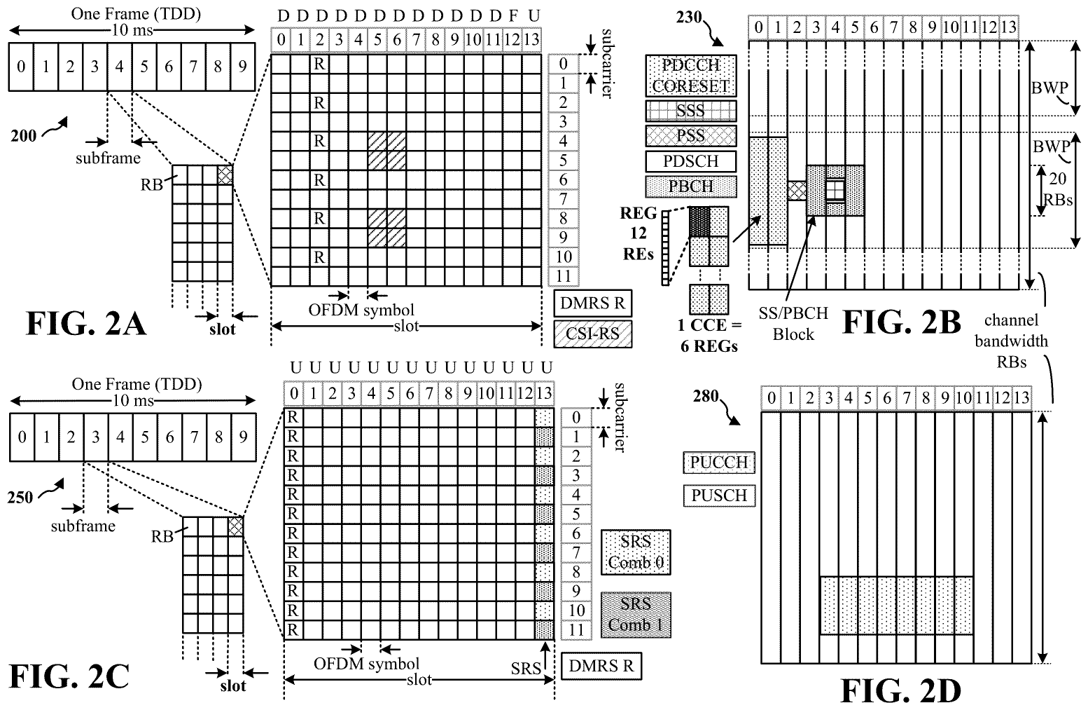

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

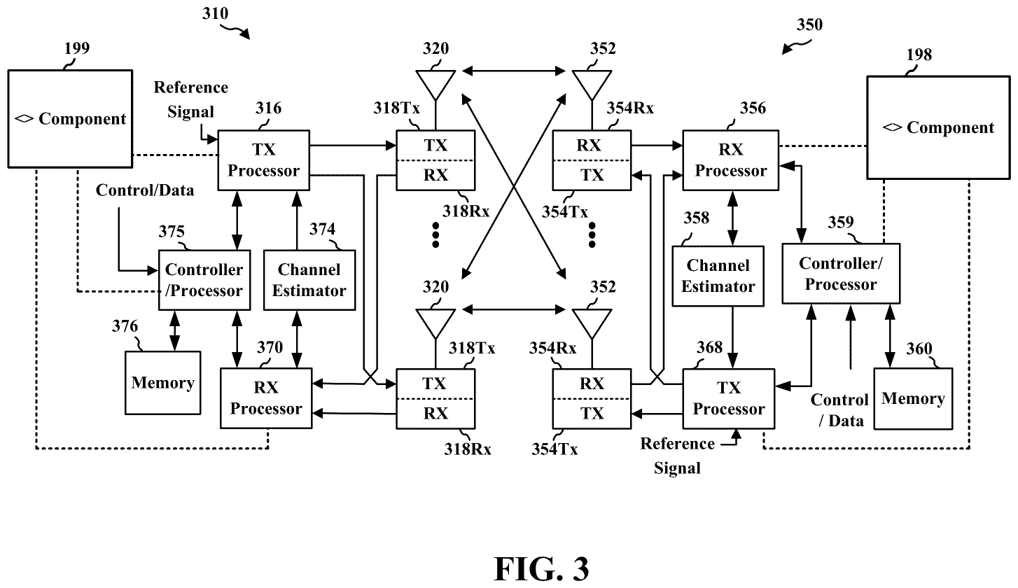

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the dynamic waveform switching component 198 of FIG. 1. At least one of the TX processor 316, the RX processor 370, and the controller/processor 375 may be configured to perform aspects in connection with the dynamic waveform switching component 199 of FIG. 1.

In one aspect, in multiple physical random access channel (PRACH) transmissions, multiple PRACH may be transmitted using the same type of beams for 4-step RACH procedure. That is, in a type-1 PRACH procedure including of the exchange of four PRACH transmissions, the four (4) random access messages may be transmitted using the same type of beams. In some aspects, the network including a base station and the UE may be configured to transmit the PRACH messages using different beams for the 4-step RACH procedure. That is, if the base station and the UE may support the waveform switching for the 4-step RACH procedure, the multiple PRACH transmissions may be sent using a particular waveform.

In some aspects, the waveform switching for the PRACH may be configured for FR2 and other frequency bands, e.g., FR1, FR4, FR2-2, and/or FR5, or the EHF band, when applicable. The waveform switching may be applied to short PRACH formats, and can also be apply to other formats when applicable. In one example, the waveform switching may be provided to support dynamic waveform switching between cyclic prefix (CP) orthogonal frequency division multiplexing (OFDM) (CP-OFDM) or discrete Fourier transform (DFT) spread OFDM (DFT-s-OFDM).

In some aspects, the waveform switching may be associated with various power domain enhancements. In one aspect, the power domain enhancements may include providing increased UE power high limit for carrier aggregation (CA) and dual connectivity (DC). That is, the waveform switching may be configured in associated. In another aspect, the power domain enhancements may include reducing maximum power reduction (MPR)/peak-to-average power ratios (PAR), including frequency domain spectrum shaping with and without spectrum extension for DFT-S-OFDM and tone reservation.

In some aspects, PUSCH may be associated with various waveforms, e.g., CP-OFDM, DFT-s-OFDM, etc. Different waveforms may provide different benefits for UEs at different times or at different locations within a cell. In one aspect, the waveform used to transmit the PUSCH may be the DFT-s-OFDM. The DFT-S-OFDM may be a default configuration for the UEs at the cell edge. That is, the UEs disposed at edge of the cell may be configured to transmit the PUSCH using the DFT-S-OFDM waveform. The DFT-S-OFDM waveform may have a low peak-to-average-power (PAPR) characteristic and hence may be allowed to have an increased transmission power, which may improve communication with the network for a UE that is closer to a cell edge. PUSCH transmission using the DFT-S-OFDM waveform may also allow a more robust MCS options, e.g., lower code rates and pi/2 (π/2) binary phase shift keying (BPSK) modulation option). The DFT-S-OFDM wave scheme may be defined with single-layer transmission. The more robust MCS options may improve communication with the network for a UE that is closer to a cell edge.

In another aspect, the waveform used to transmit the PUSCH may be the CP-OFDM. The CP-OFDM may have an increased spectrally efficiency since it is associated with MCS tables that may provide more spectrally efficient MCSs and also allow multiple-layers transmission. Accordingly, the CP-OFDM waveform may be configured for UEs that experience good cell coverage, such as UEs that are closer to a base station or network transmission point within the cell. The use of the CP-OFDM waveform may provide added spectral efficiency for communication with the UEs at the closer location, which may not benefit as much as more distant UEs from the increased transmission power and more robust MCS of a DFT-S-OFDM waveform.

In another aspect, different UEs with low or moderate mobility may be disposed at different locations under the cell coverage range at different times and may be configured to use different transmission waveform configurations according to the experienced reception conditions. That is, for different UEs with low or moderate mobility may be configured with different waveform configured to the PUSCH transmission based on the respective conditions, e.g., the (lowest SNR edge/cell edge or mid/high SNR range.

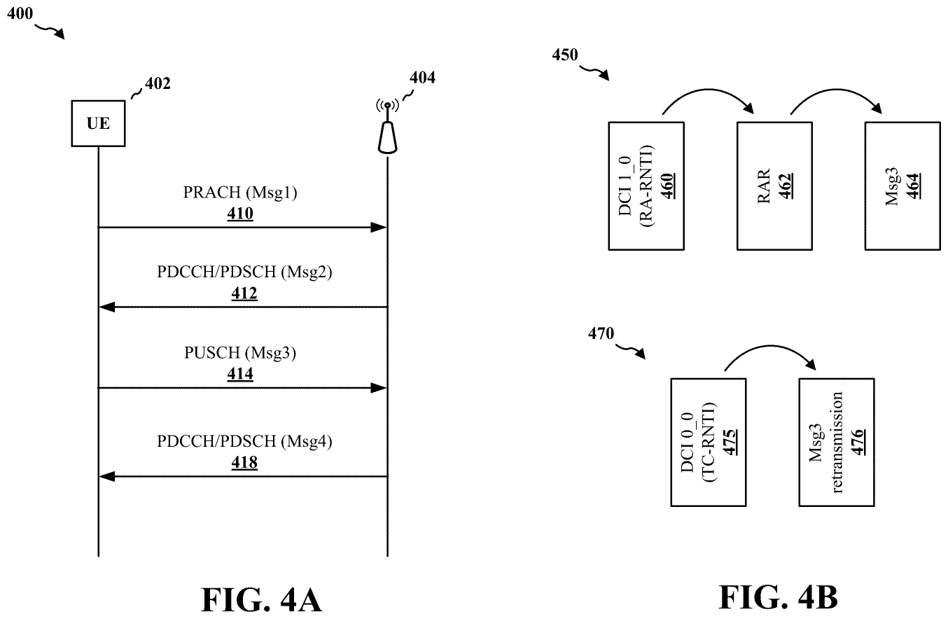

FIG. 4A is a type-1 RACH procedure 400 of a method of wireless communication. The RACH procedure 400 may include a UE 402 and a base station 404. Table 1 shows the RACH messages for the RACH procedure.

TABLE 1
RACH messages

| Message | PHY channel | Content |
|---|---|---|
| Msg1 | PRACH | PRACH preamble |
| Msg2 | PDCCH, PDSCH | Timing advance, UL grant for Msg3, |
| | (RAR) | TC-RNTI, etc. |
| Msg3 | PUSCH | RRC connection request, scheduling |
| | | request, buffer status etc. |
| Msg4 | PDCCH, PDSCH | Contention resolution message |

First, the UE 402 may start the initial access including DL synchronization (sync) and UL sync procedures. The DL sync may be achieved from decoding minimum system information (MSI) including master information block (MIB) and remaining system information (RMSI) including SIB 1. By decoding the SIB 1, the UE may acquire information for UL sync procedure, e.g., the random access procedure. The initial access RACH may be a contention based random access (CBRA) four step procedure.

The UE 402 may initiate the RACH procedure by transmitting a first random access message (Msg1) 410 to the base station 404. The Msg1 410 may include a PRACH preamble including a cyclic prefix (CP) and preamble sequence that the base station may use for RACH procedure. The base station 404 may receive the Msg1 410 including the PRACH preamble, and transmit a second random access message (Msg2) 412 to the UE 402.

Once the UE 402 transmits the Msg1 RACH preamble, the UE 402 monitors for a response during an RAR-window, configured by rar-WindowLength IE in the SIB, to receive the PDCCH including the DCI format 1_0 (DCI 1_0) transmission from the base station 404, the DCI 1_0 scrambled with a random access (RA) radio network temporary identifier (RNTI) (RA-RNTI). Once the UE 402 successfully decodes the PDCCH the UE 402 may get the resource block (RB) information to receive the Msg2 412 in the scheduled PDSCH. The Msg2 412 may include a Random Access Response (RAR), and the UE may decode the PDSCH carrying the Mgs2 412 including the RAR. The RAR.

Based on the RAR in the Msg2 412 received from the base station 404, the UE 402 may transmit, to the base station, a third random access message (Msg3) 414 including an RRC connection request, a scheduling request, a buffer status, etc. In response to the Msg3 414, the base station 404 may transmit, to the UE 402, a fourth random access message (Msg4) 418 including a contention resolution message.

FIG. 4B illustrates various transmissions of the Msg3 PUSCH of a method of wireless communication, including an initial transmission 450 of the Msg3 PUSCH or a retransmission 470 of the Msg3 PUSCH.

Referring to the initial transmission 450 of the Msg3 PUSCH, the base station 404 may instruct the UE 402 to initially transmit the Msg3 464. That is, the base station 404 may first transmit the DCI 1_0 460 to the UE 402 in the PDCCH 412 of the Msg2 412 and including information for receiving the RAR 462. The UE 402 may receive the RAR 462 in the PDSCH of the Msg2 412 using the information. The RAR 462 may include information for the UE to use to transmit the Msg3 464. Based on the RAR 462 received in the PDSCH of the Msg2 412, the UE 402 may transmit the Msg3 464 including the PUSCH to the base station. Accordingly, the UE 402 may receive the PDCCH including the DCI 1_0 460 and the PDSCH including the RAR 462 in the Msg2 412. Accordingly, the UE 402 may send the initial transmission of the Msg3 464 to the base station 404. Here, the initial transmission of the Msg3 464 may be transmitted based on a waveform configuration.

Referring to the retransmission 470 of the Msg3 PUSCH (e.g., 464), the base station 404 may instruct the UE 402 to retransmit the Msg3 to the base station. That is, the base station 404 may determine that the Msg3 PUSCH (e.g., 464) was not successfully received from the UE 402, and the base station 404 may indicate a HARQ feedback to the UE 402 to request a retransmission of the Msg3 PUSCH. The base station 404 may transmit a DCI format 0_0 (DCI 0_0) 475 including the HARQ feedback instructing a retransmission of the Msg3 PUSCH, and the UE 402 may transmit the Msg3 retransmission 476 to the base station 404. Accordingly, the UE 402 may transmit the Msg3 retransmission 476 to the base station 404. Here, the Msg3 retransmission 476 may be transmitted based on a waveform configuration.

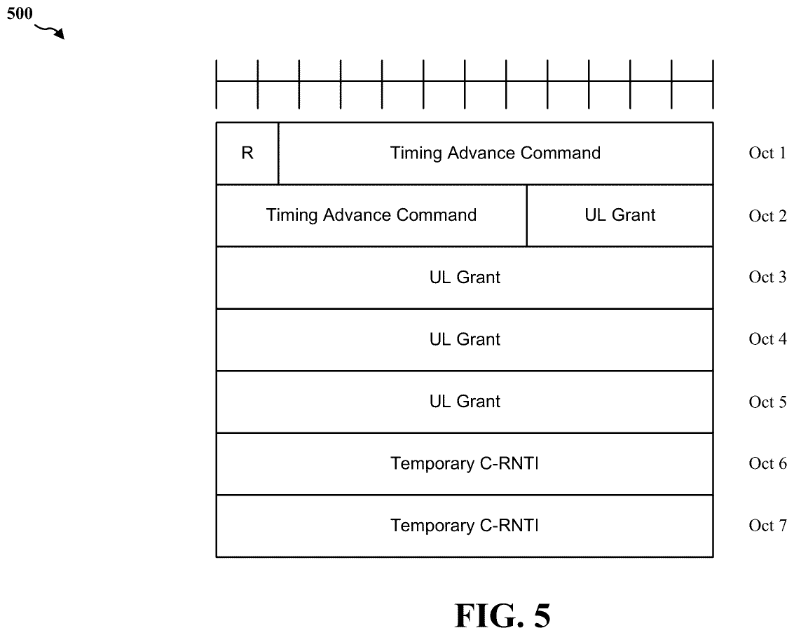

FIG. 5 illustrates example content of a MAC RAR 500 that may be used to indicate the dynamic waveform configuration of a method of wireless communication. The MAC RAR 500 may be included in the PDSCH of the Msg2 (e.g., Msg2 412). The PDSCH may contain a MAC PDU and a MAC payload of the MAC RAR 500.

In one aspect, the MAC PDU may include a MAC subheader for RAR. The MAC subheader may be octet aligned and include an extension (E) field, a type (T) field, a reserved (R) field, a backoff indicator (BI) field, or a random access preamble identifier (RAPID) field. The E field may indicate if the MAC subPDU including this MAC subheader is the last MACsubPDU or not in the MAC PDU. E field may be set to “1” to indicate at least another MAC subPDU follows, or set to “0” to indicate that the MAC subPDU including this MAC subheader is the last MAC subPDU in the MAC PDU. The T field may indicate whether the MAC subheader contains a Random Access Preamble ID or a Backoff Indicator. The T field is set to “0” to indicate the presence of the BI field in the subheader, or set to “1” to indicate the presence of the RAPID field in the subheader. The R bit field may be set to “0.” The BI field may identify the overload condition in the cell. For example, the BI field may have a size is 4 bits to represent 16 possible index. The Backoff time value corresponding to each index value may be configured. The RAPID field may identify the transmitted random access preamble. For example, the size of the RAPID field may be 6 bits. If the RAPID in the MAC subheader of a MAC subPDU corresponds to one of the random access preambles configured for SI request, the MAC RAR is not included in the MAC subPDU.

In another aspect, the MAC payload for random access response may have a fixed size depicted in FIG. 5 and include a reserved bit (R), a timing advance command, a UL grant, and a temporary C-RNTI. The R bit field may be set to “0.” The timing advance command field may indicate the index value TA used to control the amount of timing adjustment for the MAC entity to apply. For example, the size of the timing advance command field may be 12 bits. The UL Grant field may indicate the resources to be used on the uplink i.e. Msg3. For example, the size of the UL Grant field may be 27 bits. The Temporary C-RNTI field may indicate the temporary identity that may be used by the MAC entity during the random access procedure. For example, the size of the Temporary C-RNTI field may be 16 bits.

The content of the UL grant field may include a frequency hopping flag, modulation and coding scheme (MCS), or a transmit power control (TPC) command value. The frequency hopping flag may indicate whether the UE transmits the PUSCH with the frequency hopping. The frequency hopping flag may be set to “0” to indicate that the UE transmits the PUSCH without frequency hopping, and otherwise, the UE transmits the PUSCH with frequency hopping. The MCS provides an index table of the applicable MCS index table for PUSCH for the UE, from which the UE may determine the MCS of the PUSCH transmission. The TPC command value may be used for setting the power of the PUSCH transmission. The TPC command value may be interpreted according a configured table.

In one aspect, the waveform for the Msg3 PUSCH transmission in RACH configuration may be cell-specific. That is, the waveform for transmitting the Msg3 PUSCH may be provided in a RACH configuration provided per cell. For example, the value of a precoder parameter, such as a msg3-transformPrecoder parameter, may indicate the waveform for transmitting the Msg3 PUSCH transmission to the base station. As an example, the value of msg3-transformPrecoder parameter being enabled may refer to the waveform for PUSCH transmission being DFT-s-OFDM, and being disabled may refer to the waveform for PUSCH transmission being CP-OFDM.

As different waveforms may provide benefits to UEs at different locations or experiencing different channel conditions, in some aspects, the aspects presented herein provide for selection or switching of the waveform for the Msg 3 PUSCH transmission/retransmissions, which may increase the coverage of the PUSCH. For example, the UE may be configured to use a waveform for the PUSCH based on the radio condition at the UE, which may improve coverage for the UE.

In case of the initial Msg3 transmission (e.g., the initial transmission 450 of the Msg3 PUSCH of FIG. 4B), the waveform for the initial Msg3 PUSCH may be indicated in the Msg2 (e.g., Msg2 412 of FIG. 4A). That is, when the station transmits, to the UE, the Msg2 including the RAR in response to the Msg1 including the PRACH preamble, the base station may indicate the UE with a waveform configuration to be applied for the Msg3 PUSCH transmissions. In one aspect, the waveform for the initial Msg3 PUSCH may be indicated in DCI, such as in a reserved bit field in the DCI 1_0 with CRC scrambled by RA-RNTI (e.g., DCI 1_0 460) in the Msg2 (e.g., Msg2 412 of FIG. 4A).

In another aspect, the waveform for the initial Msg3 PUSCH may be indicated in a MAC PDU, such as in a reserved bit in the MAC PDU of the MAC RAR or the reserved bit in the MAC payload of the MAC RAR in the Msg2 (e.g., Msg2 412 of FIG. 4A). In one example, the reserved bit in the MAC PDU of the MAC RAR in the Msg2 may indicate the waveform for the UE to transmit the Msg3 PUSCH to the base station. In another example, the reserved bit in the MAC payload of the MAC RAR in the Msg2 may indicate the waveform for the UE to transmit the Msg3 PUSCH to the base station.

In another aspect, the waveform for the initial Msg3 PUSCH may be indicated in the channel state information (CSI) request field in the UL grant of the MAC RAR in the Msg2 (e.g., Msg2 412 of FIG. 4A).

In some aspects, the UE 602 may use the waveform configuration indicated in the RACH configuration, e.g., a cell-specific waveform configuration, e.g., if a waveform is not indicated in DCI or a MAC PDU.

In some aspects, a waveform may be indicated to the UE 602 to use for a Msg3 PUSCH retransmission, which may be different than a waveform indicated for an initial Msg PUSCH transmission. In case of the Msg3 retransmission (e.g., the retransmission 470 of the Msg3 PUSCH of FIG. 4B), in one aspect, the waveform for the Msg3 retransmission may be indicated by a new data indicator or a HARQ process number field in the DCI 0_0 with CRC scrambled by TC-RNTI (e.g., DCI 0_0 475). That is, when the base station transmits the DCI 0_0 to the UE to instruct the UE to transmit Msg3 PUSCH retransmissions, the base station may indicate the UE with a waveform configuration to be applied for the Msg3 PUSCH retransmissions. In one example, the DCI 0_0 transmitted from the base station to the UE may include the new data indicator field to indicate the waveform for the Msg3 PUSCH retransmissions. In another example, the DCI 0_0 transmitted from the base station to the UE may use the HARQ process number field to indicate the waveform for the Msg3 PUSCH retransmissions. When the HARQ process number field is used to indicate the waveform for the Msg3 PUSCH retransmissions, the least significant bit (LSB) or the most significant bit (MSB) of the 4-bit field of the HARQ processing number field may be used for the indication. The one-bit field of the 4-bit field of the HARQ processing number field may be configured or specified.

In another aspect, the waveform for the Msg3 retransmission may follow the same waveform configuration used for the initial Msg3 PUSCH transmission. That is, without receiving, from the base station, an additional indication of the waveform for the Msg3 PUSCH retransmissions, the UE may apply the waveform configuration applied for the Msg3 PUSCH transmission to the Msg3 PUSCH retransmissions.

In another aspect, the waveform for the Msg3 retransmission may use the other waveform configuration different from the wave form used for the initial Msg3 PUSCH transmission. That is, without receiving, from the base station, an additional indication of the waveform for the Msg3 PUSCH retransmissions, the UE may not apply the waveform configuration that was applied for the Msg3 PUSCH transmission to the Msg3 PUSCH retransmissions. Because the previous attempt of PUSCH transmission using the first waveform configuration was not successful, the UE may transmit the PUSCH retransmission using a different waveform configuration. For example, the UE may be configured to apply the CP-OFDM for the initial PUSCH transmission and DFT-s-OFDM for the PUSCH retransmission, and the UE may apply the CP-OFDM for the initial PUSCH transmission and DFT-s-OFDM for the PUSCH retransmission.

In some aspects, the base station may instruct the waveform switching to the UE based on the UE's capability to support the dynamic waveform switching. However, the Msg3 PUSCH transmission may be a part of the initial access procedure, and the UE capability may be unknown to the base station during the initial access procedure. Accordingly, the UE may indicate, to the base station, whether the UE supports the dynamic waveform switching in RACH signaling. That is, the UE may indicate its capability to support the dynamic waveform switching to the base station, and the base station may determine to indicate the waveform switching to the UE in the Msg2 based on the received UE capability to support the dynamic waveform switching.

In one aspect, the UE may indicate its capability of supporting the dynamic waveform switching for Msg3 PUSCH in the PRACH transmission, e.g., via RACH occasion or RACH preamble. That is, the UE may explicitly indicate, to the base station, that the UE has the capability to support the dynamic waveform switching for Msg3 PUSCH in the Msg1, e.g., based on the RACH occasion or the RACH preamble that the UE transmits. For example, if the UE transmits the Msg1 in a first RACH occasion, it may indicate that the UE does not support dynamic waveform switching for the Msg3 PUSCH. If the UE transmits the Msg1 in a second RACH occasion, the use of the second RACH occasion may indicate that the UE does support dynamic waveform switching for the Msg3 PUSCH. Similarly, if the UE transmits a first preamble in the Msg1, the preamble may indicate that the UE does not support dynamic waveform switching for the Msg3 PUSCH. If the UE transmits a second preamble in the Msg1, the use of the second preamble may indicate that the UE does support dynamic waveform switching for the Msg3 PUSCH.

In another aspect, the UE may indicate its support for the dynamic waveform switching for Msg3 PUSCH by reporting a support for another capability. That is, the UE may implicitly indicate its support for the dynamic waveform switching for Msg3 PUSCH through an indication of the support for another capability, which may be agreed and understood by the base station that the support for another capability also means the support for the dynamic waveform switching. For example, the UE may indicate its support for multiple PRACH transmissions to indicate that the UE has the support for the dynamic waveform switching, and the base station may be configured to receive the indication from the UE of its support for the multiple PRACH transmission and understand that the UE also has the capabilities to support the dynamic waveform switching.

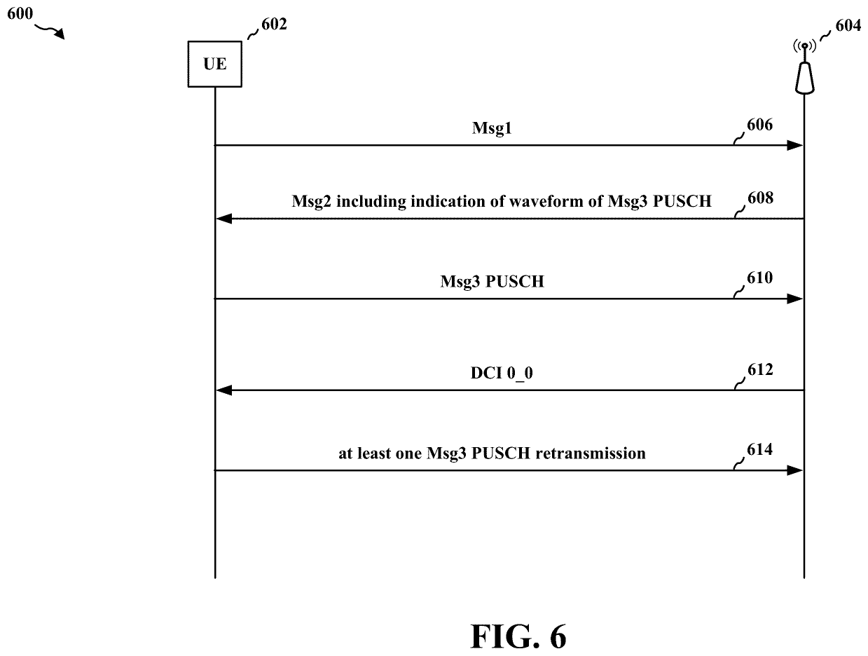

FIG. 6 is a call-flow diagram 600 of a method of wireless communication. The call-flow diagram 600 may include a UE 602 and a base station 604. During an initial access procedure, the base station 604 may transmit a Msg2 including an indication of a waveform for the Msg3 PUSCH transmission. The UE 602 may receive the Msg2 including indication of the waveform for the Msg3 PUSCH transmission, and the UE 602 may perform a dynamic waveform switching in response to the received indication of the waveform for the Msg3 PUSCH transmission by transmitting the Msg3 PUSCH based on the indication of the waveform received from the base station 604.

At 606, the UE 602 may transmit, to the base station 604, a Msg1, and the base station 604 may receive the Msg1. The Msg1 may include a PRACH preamble including a CP and preamble sequence that the base station 604 may use for RACH procedure. The base station 604 may generate the RAR based on the Msg1 received from the UE 602.

In some aspects, the Msg1 may indicate the UE's support for waveform switching for the Msg3 PUSCH. For example, the support for the waveform switching may be indicated in at least one of a RACH occasion of the Msg1, a RACH preamble comprised in the Msg1, or an indication of another capability. In one aspect, the UE's capability to support the dynamic waveform switching for Msg3 PUSCH may be explicitly indicated in the Msg1, e.g., the RACH occasion or the RACH preamble. In another aspect, the UE's capability to support the dynamic waveform switching for Msg3 PUSCH may be implicitly indicated through an indication of the support for another capability, which may be agreed and understood by the base station 604 that the support for another capability also means the support for the dynamic waveform switching.

At 608, the base station 604 may transmit an indication of a waveform of a Msg3 PUSCH. The UE 602 may receive, from the base station 604, an indication of a waveform of a Msg3 PUSCH. Here, the indication of the waveform of the Msg3 PUSCH may include the CP-OFDM or the DFT-S-OFDM.

In one aspect, the indication of the waveform for the Msg3 PUSCH may be in a DCI associated with a RAR in a Msg2. For example, the waveform for the initial Msg3 PUSCH may be indicated in a reserved bit field in the DCI 1_0 with CRC scrambled by RA-RNTI (e.g., DCI 1_0 460) in the Msg2 (e.g., Msg2 412 of FIG. 4A).

In some aspects, the indication of the waveform for the Msg3 PUSCH may be in a RAR to the Msg1. In one aspect, the indication of the waveform for the Msg3 PUSCH may be in at least one of a first bit of a MAC PDU of the RAR or a second bit of a MAC payload of the RAR. In one example, the reserved bit in the MAC PDU of the MAC RAR in the Msg2 may indicate the waveform for the UE 602 to transmit the Msg3 PUSCH to the base station 604. In another example, the reserved bit in the MAC payload of the MAC RAR in the Msg2 may indicate the waveform for the UE 602 to transmit the Msg3 PUSCH to the base station 604.

In another aspect, the indication of the waveform for the Msg3 PUSCH may be in CSI request field of an uplink grant in the RAR. That is, the waveform for the initial Msg3 PUSCH may be indicated in the channel state information (CSI) request field in the UL grant of the MAC RAR in the Msg2 (e.g., Msg2 412 of FIG. 4A).

At 610, the UE 602 may transmit, to the base station 604, the Msg3 PUSCH using the waveform indicated by the base station 604. The base station 604 may receive, the Msg3 PUSCH using the indicated waveform. The indication of the waveform for the Msg3 PUSCH may be included in at least one of a DCI associated with a RAR in a Msg2, a MAC PDU or MAC payload of the RAR, or the CSI request field of an uplink grant in the RAR of the Msg2.

At 612, the base station 604 may transmit, a HARQ response based on the Msg3 PUSCH transmitted to the base station 604, the HARQ response indicating a retransmission waveform. The UE 602 may receive, from the base station 604, the HARQ response based on the Msg3 PUSCH transmitted to the base station 604, the HARQ response indicating a retransmission waveform. That is, the base station 604 may determine that the Msg3 PUSCH was not successfully received from the UE 602, and the base station 604 may transmit a DCI 0_0 including the HARQ feedback requesting a retransmission of the Msg3 PUSCH.

In one aspect, the retransmission waveform may be indicated in a reserved bit of DCI associated with the HARQ response. That is, when the base station 604 transmits the DCI 0_0 to the UE 602 to instruct the UE 602 to transmit Msg3 PUSCH retransmissions, the base station 604 may indicate the UE 602 with a waveform configuration to be applied for the Msg3 PUSCH retransmissions. In one example, the DCI 0_0 transmitted from the base station 604 to the UE 602 may include the new data indicator field to indicate the waveform for the Msg3 PUSCH retransmissions. In another example, the DCI 0_0 transmitted from the base station 604 to the UE 602 may use the HARQ process number field to indicate the waveform for the Msg3 PUSCH retransmissions.

At 614, the UE 602 may transmit, to the base station 604, at least one retransmission of the Msg3 PUSCH. The base station 604 may receive at least one retransmission of the Msg3 PUSCH. In one aspect, the UE 602 may transmit at least one retransmission of the Msg3 PUSCH using the retransmission waveform based on the HARQ response received from the base station 604. That is, the at least one retransmission of the Msg3 PUSCH may be based on the indication of the waveform for the Msg3 PUSCH retransmission in the DCI 0_0 including the HARQ response at 612.

In another aspect, the UE 602 may transmit the Msg3 PUSCH retransmission based on the waveform applied for the initial transmission of the Msg3 PUSCH at 610. In one example, the UE 602 may transmit, to the base station 604, at least one retransmission of the Msg3 PUSCH using the waveform indicated for the initial transmission of the Msg3 PUSCH. In another example, the UE 602 may transmit, to the base station 604, at least one retransmission of the Msg3 PUSCH using another waveform different from the waveform indicated for the initial transmission of the Msg3 PUSCH.

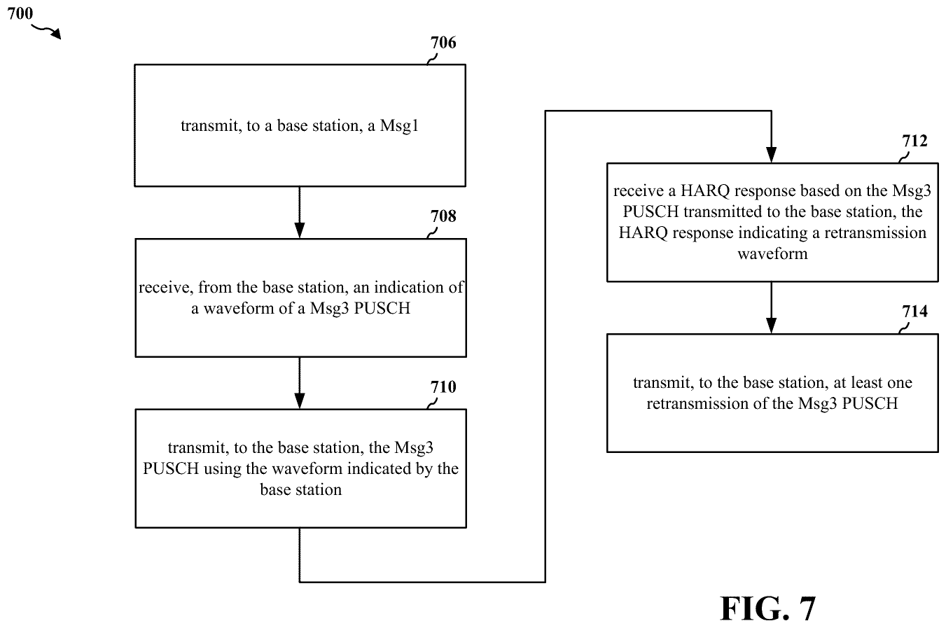

FIG. 7 is a flowchart 700 of a method of wireless communication. The method may be performed by a UE (e.g., the UE 104; the apparatus 1104). During an initial access procedure, a UE may receive the Msg2 including indication of the waveform for the Msg3 PUSCH transmission, and the UE may perform a dynamic waveform switching in response to the received indication of the waveform for the Msg3 PUSCH transmission by transmitting the Msg3 PUSCH based on the indication of the waveform received from the base station.

At 706, the UE may transmit, to the base station, a Msg1. The Msg1 may include a PRACH preamble including a CP and preamble sequence that the base station may use for RACH procedure. The base station may generate the RAR based on the Msg1 received from the UE. In some aspects, the Msg1 may indicate the UE's support for waveform switching for the Msg3 PUSCH. For example, the support for the waveform switching may be indicated in at least one of a RACH occasion of the Msg1, a RACH preamble comprised in the Msg1, or an indication of another capability. In one aspect, the UE's capability to support the dynamic waveform switching for Msg3 PUSCH may be explicitly indicated in the Msg1, e.g., the RACH occasion or the RACH preamble. In another aspect, the UE's capability to support the dynamic waveform switching for Msg3 PUSCH may be implicitly indicated through an indication of the support for another capability, which may be agreed and understood by the base station that the support for another capability also means the support for the dynamic waveform switching. For example, at 606, the UE 602 may transmit, to the base station 604, a Msg1. Furthermore, 706 may be performed by a dynamic waveform switching component 198.

At 708, the UE may receive, from the base station, an indication of a waveform of a Msg3 PUSCH. Here, the indication of the waveform of the Msg3 PUSCH may include the CP-OFDM or the DFT-S-OFDM. In one aspect, the indication of the waveform for the Msg3 PUSCH may be in a DCI associated with a RAR in a Msg2. For example, the waveform for the initial Msg3 PUSCH may be indicated in a reserved bit field in the DCI 1_0 with CRC scrambled by RA-RNTI (e.g., DCI 1_0 460) in the Msg2 (e.g., Msg2 412 of FIG. 4A). In some aspects, the indication of the waveform for the Msg3 PUSCH may be in a RAR to the Msg1. In one aspect, the indication of the waveform for the Msg3 PUSCH may be in at least one of a first bit of a MAC PDU of the RAR or a second bit of a MAC payload of the RAR. In one example, the reserved bit in the MAC PDU of the MAC RAR in the Msg2 may indicate the waveform for the UE to transmit the Msg3 PUSCH to the base station. In another example, the reserved bit in the MAC payload of the MAC RAR in the Msg2 may indicate the waveform for the UE to transmit the Msg3 PUSCH to the base station. In another aspect, the indication of the waveform for the Msg3 PUSCH may be in CSI request field of an uplink grant in the RAR. That is, the waveform for the initial Msg3 PUSCH may be indicated in the channel state information (CSI) request field in the UL grant of the MAC RAR in the Msg2 (e.g., Msg2 412 of FIG. 4A). For example, at 608, the UE 602 may receive, from the base station 604, an indication of a waveform of a Msg3 PUSCH. Furthermore, 708 may be performed by the dynamic waveform switching component 198.

At 710, the UE may transmit, to the base station, the Msg3 PUSCH using the waveform indicated by the base station. The indication of the waveform for the Msg3 PUSCH may be included in at least one of a DCI associated with a RAR in a Msg2, a MAC PDU or MAC payload of the RAR, or the CSI request field of an uplink grant in the RAR of the Msg2. For example, at 610, the UE 602 may transmit, to the base station 604, the Msg3 PUSCH using the waveform indicated by the base station 604. Furthermore, 710 may be performed by the dynamic waveform switching component 198.

At 712, the UE may receive, from the base station, the HARQ response based on the Msg3 PUSCH transmitted to the base station, the HARQ response indicating a retransmission waveform. That is, the base station may determine that the Msg3 PUSCH was not successfully received from the UE, and the base station may transmit a DCI 0_0 including the HARQ feedback requesting a retransmission of the Msg3 PUSCH. In one aspect, the retransmission waveform may be indicated in a reserved bit of DCI associated with the HARQ response. That is, when the base station transmits the DCI 0_0 to the UE to instruct the UE to transmit Msg3 PUSCH retransmissions, the base station may indicate the UE with a waveform configuration to be applied for the Msg3 PUSCH retransmissions. In one example, the DCI 0_0 transmitted from the base station to the UE may include the new data indicator field to indicate the waveform for the Msg3 PUSCH retransmissions. In another example, the DCI 0_0 transmitted from the base station to the UE may use the HARQ process number field to indicate the waveform for the Msg3 PUSCH retransmissions. For example, at 612, the UE 602 may receive, from the base station 604, the HARQ response based on the Msg3 PUSCH transmitted to the base station 604, the HARQ response indicating a retransmission waveform. Furthermore, 712 may be performed by the dynamic waveform switching component 198.

At 714, the UE may transmit, to the base station, at least one retransmission of the Msg3 PUSCH. The base station may receive at least one retransmission of the Msg3 PUSCH. In one aspect, the UE may transmit at least one retransmission of the Msg3 PUSCH using the retransmission waveform based on the HARQ response received from the base station. That is, the at least one retransmission of the Msg3 PUSCH may be based on the indication of the waveform for the Msg3 PUSCH retransmission in the DCI 0_0 including the HARQ response at 712. In another aspect, the UE may transmit the Msg3 PUSCH retransmission based on the waveform applied for the initial transmission of the Msg3 PUSCH at 710. In one example, the UE may transmit, to the base station, at least one retransmission of the Msg3 PUSCH using the waveform indicated for the initial transmission of the Msg3 PUSCH. In another example, the UE may transmit, to the base station, at least one retransmission of the Msg3 PUSCH using another waveform different from the waveform indicated for the initial transmission of the Msg3 PUSCH. For example, at 614, the UE 602 may transmit, to the base station 604, at least one retransmission of the Msg3 PUSCH. Furthermore, 714 may be performed by the dynamic waveform switching component 198.

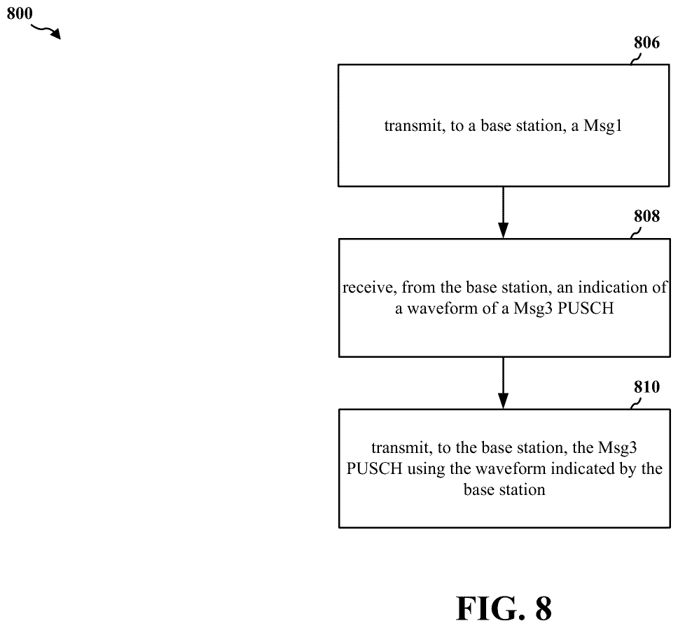

FIG. 8 is a flowchart 800 of a method of wireless communication. The method may be performed by a UE (e.g., the UE 104; the apparatus 1104). During an initial access procedure, a UE may receive the Msg2 including indication of the waveform for the Msg3 PUSCH transmission, and the UE may perform a dynamic waveform switching in response to the received indication of the waveform for the Msg3 PUSCH transmission by transmitting the Msg3 PUSCH based on the indication of the waveform received from the base station.

At 806, the UE may transmit, to the base station, a Msg1. The Msg1 may include a PRACH preamble including a CP and preamble sequence that the base station may use for RACH procedure. The base station may generate the RAR based on the Msg1 received from the UE. In some aspects, the Msg1 may indicate the UE's support for waveform switching for the Msg3 PUSCH. For example, the support for the waveform switching may be indicated in at least one of a RACH occasion of the Msg1, a RACH preamble comprised in the Msg1, or an indication of another capability. In one aspect, the UE's capability to support the dynamic waveform switching for Msg3 PUSCH may be explicitly indicated in the Msg1, e.g., the RACH occasion or the RACH preamble. In another aspect, the UE's capability to support the dynamic waveform switching for Msg3 PUSCH may be implicitly indicated through an indication of the support for another capability, which may be agreed and understood by the base station that the support for another capability also means the support for the dynamic waveform switching. For example, at 606, the UE 602 may transmit, to the base station 604, a Msg1. Furthermore, 806 may be performed by a dynamic waveform switching component 198.

At 808, the UE may receive, from the base station, an indication of a waveform of a Msg3 PUSCH. Here, the indication of the waveform of the Msg3 PUSCH may include the CP-OFDM or the DFT-S-OFDM. In one aspect, the indication of the waveform for the Msg3 PUSCH may be in a DCI associated with a RAR in a Msg2. For example, the waveform for the initial Msg3 PUSCH may be indicated in a reserved bit field in the DCI 1_0 with CRC scrambled by RA-RNTI (e.g., DCI 1_0 460) in the Msg2 (e.g., Msg2 412 of FIG. 4A). In some aspects, the indication of the waveform for the Msg3 PUSCH may be in a RAR to the Msg1. In one aspect, the indication of the waveform for the Msg3 PUSCH may be in at least one of a first bit of a MAC PDU of the RAR or a second bit of a MAC payload of the RAR. In one example, the reserved bit in the MAC PDU of the MAC RAR in the Msg2 may indicate the waveform for the UE to transmit the Msg3 PUSCH to the base station. In another example, the reserved bit in the MAC payload of the MAC RAR in the Msg2 may indicate the waveform for the UE to transmit the Msg3 PUSCH to the base station. In another aspect, the indication of the waveform for the Msg3 PUSCH may be in CSI request field of an uplink grant in the RAR. That is, the waveform for the initial Msg3 PUSCH may be indicated in the channel state information (CSI) request field in the UL grant of the MAC RAR in the Msg2 (e.g., Msg2 412 of FIG. 4A). For example, at 608, the UE 602 may receive, from the base station 604, an indication of a waveform of a Msg3 PUSCH. Furthermore, 808 may be performed by the dynamic waveform switching component 198.

At 810, the UE may transmit, to the base station, the Msg3 PUSCH using the waveform indicated by the base station. The indication of the waveform for the Msg3 PUSCH may be included in at least one of a DCI associated with a RAR in a Msg2, a MAC PDU or MAC payload of the RAR, or the CSI request field of an uplink grant in the RAR of the Msg2. For example, at 610, the UE 602 may transmit, to the base station 604, the Msg3 PUSCH using the waveform indicated by the base station 604. Furthermore, 810 may be performed by the dynamic waveform switching component 198.

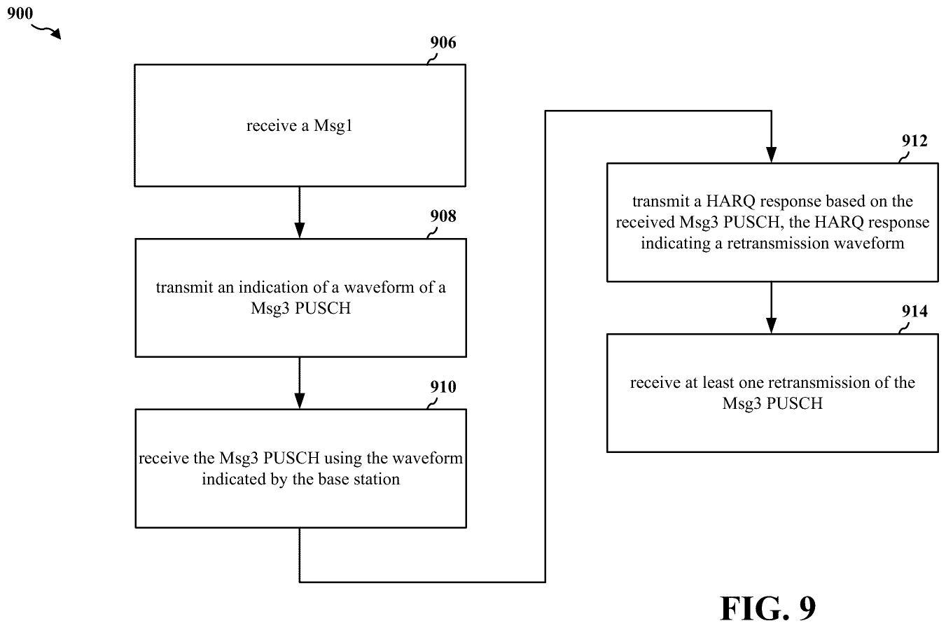

FIG. 9 is a flowchart 900 of a method of wireless communication. The method may be performed by a base station (e.g., the base station 102; the network entity 1102). During an initial access procedure, a base station may transmit a Msg2 including an indication of a waveform for the Msg3 PUSCH transmission. The base station may perform a dynamic waveform switching in response to the transmitted indication of the waveform for the Msg3 PUSCH transmission by receiving the Msg3 PUSCH based on the indication of the waveform transmitted to the UE.

At 906, the base station may receive the Msg1. The Msg1 may include a PRACH preamble including a CP and preamble sequence that the base station may use for RACH procedure. The base station may generate the RAR based on the Msg1 received from the UE. In some aspects, the Msg1 may indicate the UE's support for waveform switching for the Msg3 PUSCH. For example, the support for the waveform switching may be indicated in at least one of a RACH occasion of the Msg1, a RACH preamble comprised in the Msg1, or an indication of another capability. In one aspect, the UE's capability to support the dynamic waveform switching for Msg3 PUSCH may be explicitly indicated in the Msg1, e.g., the RACH occasion or the RACH preamble. In another aspect, the UE's capability to support the dynamic waveform switching for Msg3 PUSCH may be implicitly indicated through an indication of the support for another capability, which may be agreed and understood by the base station that the support for another capability also means the support for the dynamic waveform switching. For example, at 606, the base station 604 may receive the Msg1. Furthermore, 906 may be performed by a dynamic waveform switching component 199.

At 908, the base station may transmit, to the UE, an indication of a waveform of a Msg3 PUSCH. Here, the indication of the waveform of the Msg3 PUSCH may include the CP-OFDM or the DFT-S-OFDM. In one aspect, the indication of the waveform for the Msg3 PUSCH may be in a DCI associated with a RAR in a Msg2. For example, the waveform for the initial Msg3 PUSCH may be indicated in a reserved bit field in the DCI 1_0 with CRC scrambled by RA-RNTI (e.g., DCI 1_0 460) in the Msg2 (e.g., Msg2 412 of FIG. 4A). In some aspects, the indication of the waveform for the Msg3 PUSCH may be in a RAR to the Msg1. In one aspect, the indication of the waveform for the Msg3 PUSCH may be in at least one of a first bit of a MAC PDU of the RAR or a second bit of a MAC payload of the RAR. In one example, the reserved bit in the MAC PDU of the MAC RAR in the Msg2 may indicate the waveform for the UE to transmit the Msg3 PUSCH to the base station. In another example, the reserved bit in the MAC payload of the MAC RAR in the Msg2 may indicate the waveform for the UE to transmit the Msg3 PUSCH to the base station. In another aspect, the indication of the waveform for the Msg3 PUSCH may be in CSI request field of an uplink grant in the RAR. That is, the waveform for the initial Msg3 PUSCH may be indicated in the channel state information (CSI) request field in the UL grant of the MAC RAR in the Msg2 (e.g., Msg2 412 of FIG. 4A). For example, at 608, the base station 604 may transmit, to the UE 602, an indication of a waveform of a Msg3 PUSCH. Furthermore, 908 may be performed by the dynamic waveform switching component 199.

At 910, the base station may receive, from the UE, the Msg3 PUSCH using the waveform indicated by the base station. The indication of the waveform for the Msg3 PUSCH may be included in at least one of a DCI associated with a RAR in a Msg2, a MAC PDU or MAC payload of the RAR, or the CSI request field of an uplink grant in the RAR of the Msg2. For example, at 610, the base station 604 may receive, from the UE 602, the Msg3 PUSCH using the waveform indicated by the base station 604. Furthermore, 910 may be performed by the dynamic waveform switching component 199.

At 912, the base station may transmit the HARQ response based on the Msg3 PUSCH received at the base station, the HARQ response indicating a retransmission waveform. That is, the base station may determine that the Msg3 PUSCH was not successfully received from the UE, and the base station may transmit a DCI 0_0 including the HARQ feedback requesting a retransmission of the Msg3 PUSCH. In one aspect, the retransmission waveform may be indicated in a reserved bit of DCI associated with the HARQ response. That is, when the base station transmits the DCI 0_0 to the UE to instruct the UE to transmit Msg3 PUSCH retransmissions, the base station may indicate the UE with a waveform configuration to be applied for the Msg3 PUSCH retransmissions. In one example, the DCI 0_0 transmitted from the base station to the UE may include the new data indicator field to indicate the waveform for the Msg3 PUSCH retransmissions. In another example, the DCI 0_0 transmitted from the base station to the UE may use the HARQ process number field to indicate the waveform for the Msg3 PUSCH retransmissions. For example, at 612, the base station 604 may receive, from the base station 604, the HARQ response based on the Msg3PUSCH transmitted to the base station 604, the HARQ response indicating a retransmission waveform. Furthermore, 912 may be performed by the dynamic waveform switching component 199.

At 914, the base station may receive at least one retransmission of the Msg3 PUSCH. In one aspect, the UE may transmit at least one retransmission of the Msg3 PUSCH using the retransmission waveform based on the HARQ response received from the base station. That is, the at least one retransmission of the Msg3 PUSCH may be based on the indication of the waveform for the Msg3 PUSCH retransmission in the DCI 0_0 including the HARQ response at 912. In another aspect, the UE may transmit the Msg3 PUSCH retransmission based on the waveform applied for the initial transmission of the Msg3 PUSCH at 910. In one example, the UE may transmit, to the base station, at least one retransmission of the Msg3 PUSCH using the waveform indicated for the initial transmission of the Msg3 PUSCH. In another example, the UE may transmit, to the base station, at least one retransmission of the Msg3 PUSCH using another waveform different from the waveform indicated for the initial transmission of the Msg3 PUSCH. For example, at 614, the base station 604 may receive at least one retransmission of the Msg3 PUSCH. Furthermore, 914 may be performed by the dynamic waveform switching component 199.

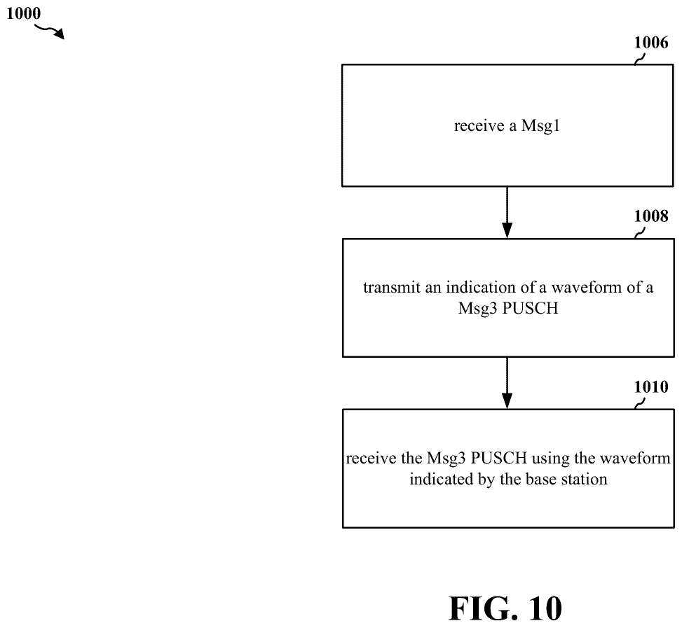

FIG. 10 is a flowchart 1000 of a method of wireless communication. The method may be performed by a base station (e.g., the base station 102; the network entity 1102). During an initial access procedure, a base station may transmit a Msg2 including an indication of a waveform for the Msg3 PUSCH transmission. The base station may perform a dynamic waveform switching in response to the transmitted indication of the waveform for the Msg3 PUSCH transmission by receiving the Msg3 PUSCH based on the indication of the waveform transmitted to the UE.

At 1006, the base station may receive the Msg1. The Msg1 may include a PRACH preamble including a CP and preamble sequence that the base station may use for RACH procedure. The base station may generate the RAR based on the Msg1 received from the UE. In some aspects, the Msg1 may indicate the UE's support for waveform switching for the Msg3 PUSCH. For example, the support for the waveform switching may be indicated in at least one of a RACH occasion of the Msg1, a RACH preamble comprised in the Msg1, or an indication of another capability. In one aspect, the UE's capability to support the dynamic waveform switching for Msg3 PUSCH may be explicitly indicated in the Msg1, e.g., the RACH occasion or the RACH preamble. In another aspect, the UE's capability to support the dynamic waveform switching for Msg3 PUSCH may be implicitly indicated through an indication of the support for another capability, which may be agreed and understood by the base station that the support for another capability also means the support for the dynamic waveform switching. For example, at 606, the base station 604 may receive the Msg1. Furthermore, 1006 may be performed by a dynamic waveform switching component 199.

At 1008, the base station may transmit, to the UE, an indication of a waveform of a Msg3 PUSCH. Here, the indication of the waveform of the Msg3 PUSCH may include the CP-OFDM or the DFT-S-OFDM. In one aspect, the indication of the waveform for the Msg3 PUSCH may be in a DCI associated with a RAR in a Msg2. For example, the waveform for the initial Msg3 PUSCH may be indicated in a reserved bit field in the DCI 1_0 with CRC scrambled by RA-RNTI (e.g., DCI 1_0 460) in the Msg2 (e.g., Msg2 412 of FIG. 4A). In some aspects, the indication of the waveform for the Msg3 PUSCH may be in a RAR to the Msg1. In one aspect, the indication of the waveform for the Msg3 PUSCH may be in at least one of a first bit of a MAC PDU of the RAR or a second bit of a MAC payload of the RAR. In one example, the reserved bit in the MAC PDU of the MAC RAR in the Msg2 may indicate the waveform for the UE to transmit the Msg3 PUSCH to the base station. In another example, the reserved bit in the MAC payload of the MAC RAR in the Msg2 may indicate the waveform for the UE to transmit the Msg3 PUSCH to the base station. In another aspect, the indication of the waveform for the Msg3 PUSCH may be in CSI request field of an uplink grant in the RAR. That is, the waveform for the initial Msg3 PUSCH may be indicated in the channel state information (CSI) request field in the UL grant of the MAC RAR in the Msg2 (e.g., Msg2 412 of FIG. 4A). For example, at 608, the base station 604 may transmit, to the UE 602, an indication of a waveform of a Msg3 PUSCH. Furthermore, 1008 may be performed by the dynamic waveform switching component 199.

At 1010, the base station may receive, from the UE, the Msg3 PUSCH using the waveform indicated by the base station. The indication of the waveform for the Msg3 PUSCH may be included in at least one of a DCI associated with a RAR in a Msg2, a MAC PDU or MAC payload of the RAR, or the CSI request field of an uplink grant in the RAR of the Msg2. For example, at 610, the base station 604 may receive, from the UE 602, the Msg3 PUSCH using the waveform indicated by the base station 604. Furthermore, 1010 may be performed by the dynamic waveform switching component 199.

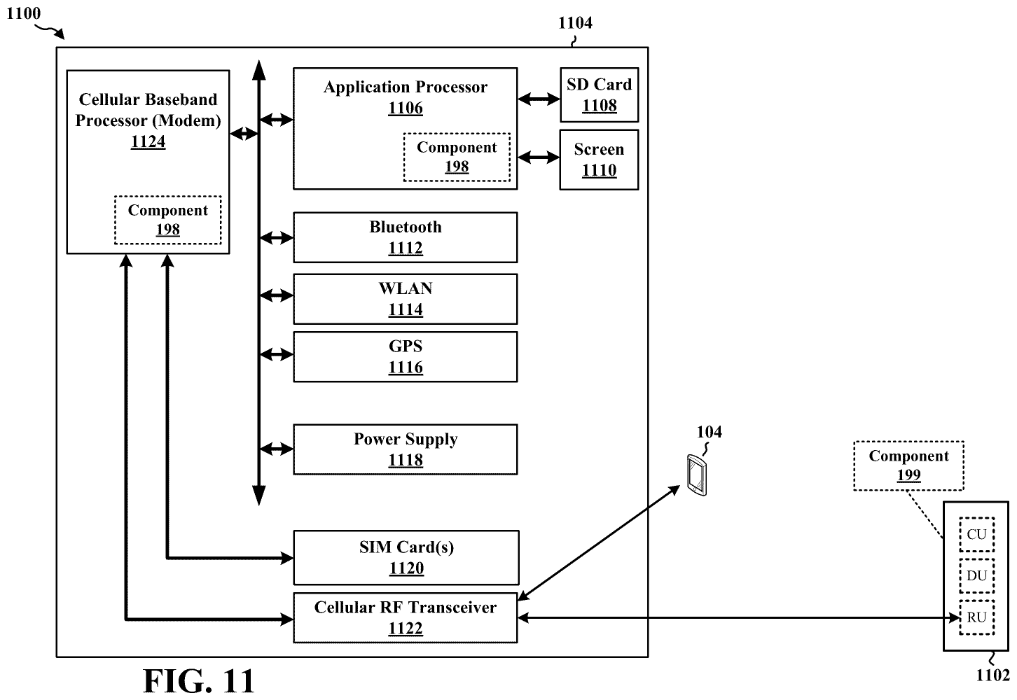

FIG. 11 is a diagram 1100 illustrating an example of a hardware implementation for an apparatus 1104 and a network entity 1102. The apparatus 1104 may be a UE, a component of a UE, or may implement UE functionality. The network entity 1102 may be a BS, a component of a BS, or may implement BS functionality. In some aspects, the apparatus 1104 may include a cellular baseband processor 1124 (also referred to as a modem) coupled to a cellular RF transceiver 1122. In some aspects, the apparatus 1104 may further include one or more subscriber identity modules (SIM) cards 1120, an application processor 1106 coupled to a secure digital (SD) card 1108 and a screen 1110, a Bluetooth module 1112, a wireless local area network (WLAN) module 1114, a Global Positioning System (GPS) module 1116, or a power supply 1118. The cellular baseband processor 1124 communicates through the cellular RF transceiver 1122 with the UE 104 and/or with an RU associated with the network entity 1102. The RU is either part of the network entity 1102 or is in communication with the network entity 1102. The network entity 1102 may include one or more of the CU, DU, and the RU. The cellular baseband processor 1124 and the application processor 1106 may each include a computer-readable medium/memory. Each computer-readable medium/memory may be non-transitory. The cellular baseband processor 1124 and the application processor 1106 are each responsible for general processing, including the execution of software stored on the computer-readable medium/memory. The software, when executed by the cellular baseband processor 1124/application processor 1106, causes the cellular baseband processor 1124/application processor 1106 to perform the various functions described supra. The computer-readable medium/memory may also be used for storing data that is manipulated by the cellular baseband processor 1124/application processor 1106 when executing software. The cellular baseband processor 1124/application processor 1106 may be a component of the UE 350 and may include the memory 360 and/or at least one of the TX processor 368, the RX processor 356, and the controller/processor 359. In one configuration, the apparatus 1104 may be a processor chip (modem and/or application) and include just the cellular baseband processor 1124 and/or the application processor 1106, and in another configuration, the apparatus 1104 may be the entire UE (e.g., see 350 of FIG. 3) and include the additional modules of the apparatus 1104.

As discussed supra, the component 198 is configured to transmit, to a base station, a Msg1, receive, from the base station, an indication of a waveform of a Msg3 PUSCH, and transmit, to the base station, the Msg3 PUSCH using the waveform indicated by the base station. The component 198 may be within the cellular baseband processor 1124, the application processor 1106, or both the cellular baseband processor 1124 and the application processor 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1104 may include a variety of components configured for various functions. In one configuration, the apparatus 1104, and in particular the cellular baseband processor 1124 and/or the application processor 1106, includes means for transmitting, to a base station, a Msg1, means for receiving, from the base station, an indication of a waveform of a Msg3 PUSCH, and means for transmitting, to the base station, the Msg3 PUSCH using the waveform indicated by the base station. The apparatus 1104 includes means for transmitting, to the base station, at least one retransmission of the Msg3 PUSCH using the waveform indicated for an initial transmission of the Msg3 PUSCH, means for receiving, from the base station, a HARQ response based on the Msg3 PUSCH transmitted to the base station, the HARQ response indicating a retransmission waveform, and means for transmitting, to the base station, at least one retransmission of the Msg3 PUSCH using the retransmission waveform based on the HARQ response received from the base station. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

As discussed supra, the component 199 is configured to receive a Msg1, output for transmission, for a UE, an indication of a waveform of a Msg3 PUSCH, and receive the Msg3 PUSCH using the waveform indicated to the UE. The component 199 may be within one or more processors (e.g., BBU(s)) of one or more of the CU, DU, and the RU. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1102 may include a variety of components configured for various functions. In one configuration, the network entity 1102 includes means for receiving a Msg1, transmitting, for a UE, an indication of a waveform of a Msg3 PUSCH, and means for receiving the Msg3 PUSCH using the waveform indicated to the UE. The network entity 1102 includes means for receiving at least one retransmission of the Msg3 PUSCH using the waveform indicated for an initial transmission of the Msg3 PUSCH, means for transmitting, for the UE, a HARQ response based on the Msg3 PUSCH received, the HARQ response indicating a retransmission waveform, and means for receiving at least one retransmission of the Msg3 PUSCH using the retransmission waveform based on the HARQ response transmitted for the UE. The means may be the component 199 of the network entity 1102 configured to perform the functions recited by the means. As described supra, the network entity 1102 may include the TX processor 316, the RX processor 370, and the controller/processor 375. As such, in one configuration, the means may be the TX processor 316, the RX processor 370, and/or the controller/processor 375 configured to perform the functions recited by the means.

(Summarize invention and solution that it provides over the problem. Provide advantages that the invention provides. Summarize invention and provide advantages separately for the independent claim and each of the key dependent claims. Make sure that advantages for the independent claim and each key dependent claim are also mentioned earlier when describing the invention so that the advantages stated here are just a summary of what was already discussed earlier.)

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used in this disclosure outside of the claims, the phrase “based on” is inclusive of all interpretations and shall not be limited to any single interpretation unless specifically recited or indicated as such. For example, the phrase “based on A” (where “A” may be information, a condition, a factor, or the like) may be interpreted as: “based at least on A,” “based in part on A,” “based at least in part on A,” “based only on A,” or “based solely on A.” Accordingly, as disclosed herein, “based on A” may, in one aspect, refer to “based at least on A.” In another aspect, “based on A” may refer to “based in part on A.” In another aspect, “based on A” may refer to “based at least in part on A.” In another aspect, “based on A” may refer to “based only on A.” In another aspect, “based on A” may refer to “based solely on A.” In another aspect, “based on A” may refer to any combination of interpretations in the alternative. As used in the claims, the phrase “based on A” shall be interpreted as “based at least on A” unless specifically recited differently.

The following aspects are illustrative only and may be combined with other aspects or teachings described herein, without limitation.

Aspect 1 is a method of wireless communication at a UE, including transmitting, to a base station, a Msg1, receiving, from the base station, an indication of a waveform of a Msg3 PUSCH, and transmitting, to the base station, the Msg3 PUSCH using the waveform indicated by the base station.

Aspect 2 is the method of aspect 1, where the indication of the waveform for the Msg3 PUSCH is in a DCI associated with a RAR in a Msg2.

Aspect 3 is the method of any of aspects 1 and 2, where the indication of the waveform for the Msg3 PUSCH is in a RAR to the Msg1.

Aspect 4 is the method of aspect 3, where the indication of the waveform for the Msg3 PUSCH is in at least one of a first bit of a MAC PDU of the RAR or a second bit of a MAC payload of the RAR.

Aspect 5 is the method of aspect 4, where the indication of the waveform for the Msg3 PUSCH is in a CSI request field of an uplink grant in the RAR.

Aspect 6 is the method of any of aspects 1 to 5, further including transmitting, to the base station, at least one retransmission of the Msg3 PUSCH using the waveform indicated for an initial transmission of the Msg3 PUSCH.

Aspect 7 is the method of any of aspects 1 to 5, further including transmitting, to the base station, at least one retransmission of the Msg3 PUSCH using another waveform different from the waveform indicated for an initial transmission of the Msg3 PUSCH.

Aspect 8 is the method of any of aspects 1 to 7, further including receiving, from the base station, a HARQ response based on the Msg3 PUSCH transmitted to the base station, the HARQ response indicating a retransmission waveform, and transmitting, to the base station, at least one retransmission of the Msg3 PUSCH using the retransmission waveform based on the HARQ response received from the base station.

Aspect 9 is the method of aspect 8, where the retransmission waveform is indicated in a reserved bit of DCI associated with the HARQ response.

Aspect 10 is the method of any of aspects 1 to 9, where the Msg1 indicates support for waveform switching for the Msg3 PUSCH.

Aspect 11 is the method of aspect 10, where the Msg1 indicates the support for the waveform switching based on at least one of a RACH occasion of the Msg1, a RACH preamble comprised in the Msg1, or an indication of another capability.

Aspect 12 is the method of any of aspects 1 to 11, where the waveform comprises CP-OFDM or DFT-S-OFDM.

Aspect 13 is an apparatus for wireless communication including at least one processor coupled to a memory and configured to implement any of aspects 1 to 12, further including a transceiver coupled to the at least one processor.

Aspect 14 is an apparatus for wireless communication including means for implementing any of aspects 1 to 12.

Aspect 15 is a non-transitory computer-readable medium storing computer executable code, where the code when executed by a processor causes the processor to implement any of aspects 1 to 12.

Aspect 16 is a method of wireless communication at a network node, including receiving a Msg1, transmitting, for a UE, an indication of a waveform of a Msg3 PUSCH, and receiving the Msg3 PUSCH using the waveform indicated to the UE. Aspect 17 is the method of aspect 16, where the indication of the waveform for the Msg3 PUSCH is in a DCI associated with a RAR in a Msg2.

Aspect 18 is the method of any of aspects 16 and 17, where the indication of the waveform for the Msg3 PUSCH is in a RAR to the Msg1.

Aspect 19 is the method of aspect 18, where the indication of the waveform for the Msg3 PUSCH is in at least one of a first bit of a MAC PDU of the RAR or a second bit of a MAC payload of the RAR.

Aspect 20 is the method of aspect 18, where the indication of the waveform for the Msg3 PUSCH is in a CSI request field of an uplink grant in the RAR.

Aspect 21 is the method of any of aspects 16 to 20, further including receiving at least one retransmission of the Msg3 PUSCH using the waveform indicated for an initial transmission of the Msg3 PUSCH.

Aspect 22 is the method of any of aspects 16 to 20, further including receiving at least one retransmission of the Msg3 PUSCH using another waveform different from the waveform indicated for an initial transmission of the Msg3 PUSCH.

Aspect 23 is the method of any of aspects 16 to 22, further including transmitting, for the UE, a HARQ response based on the Msg3 PUSCH received, the HARQ response indicating a retransmission waveform, and receiving at least one retransmission of the Msg3 PUSCH using the retransmission waveform based on the HARQ response transmitted for the UE.

Aspect 24 is the method of aspect 23, where the retransmission waveform is indicated in a reserved bit of DCI associated with the HARQ response.

Aspect 25 is the method of any of aspects 16 to 24, where the Msg1 indicates support for waveform switching for the Msg3 PUSCH, and the indication of the waveform of the Msg3 PUSCH is output based on the support for waveform switching for the Msg3 PUSCH received.

Aspect 26 is the method of aspect 25, where the Msg1 indicates the support for the waveform switching based on at least one of a RACH occasion of the Msg1, a RACH preamble comprised in the Msg1, or an indication of another capability.

Aspect 27 is the method of any of aspects 16 to 26, where the waveform comprises CP-OFDM or DFT-S-OFDM.

Aspect 28 is an apparatus for wireless communication including at least one processor coupled to a memory and configured to implement any of aspects 16 to 27, further including a transceiver coupled to the at least one processor.

Aspect 29 is an apparatus for wireless communication including means for implementing any of aspects 16 to 27.

Aspect 30 is a non-transitory computer-readable medium storing computer executable code, where the code when executed by a processor causes the processor to implement any of aspects 16 to 27.

What is claimed is:

1. An apparatus for wireless communication at a user equipment (UE), comprising:
a memory; and
at least one processor coupled to the memory and configured to:
transmit, to a base station, a first random access message (Msg1);
receive, from the base station, an indication of a waveform of a third random access message (Msg3) physical uplink shared channel (PUSCH); and
transmit, to the base station, the Msg3 PUSCH using the waveform indicated by the base station.

2. The apparatus of claim 1, wherein the indication of the waveform for the Msg3 PUSCH is in a downlink control information (DCI) associated with a random access response (RAR) in a second random access message (Msg2).

3. The apparatus of claim 1, wherein the indication of the waveform for the Msg3 PUSCH is in a random access response (RAR) to the Msg1.

4. The apparatus of claim 3, wherein the indication of the waveform for the Msg3 PUSCH is in at least one of a first bit of a medium access control (MAC) protocol data unit (PDU) of the RAR or a second bit of a MAC payload of the RAR.

5. The apparatus of claim 3, wherein the indication of the waveform for the Msg3 PUSCH is in a channel state information (CSI) request field of an uplink grant in the RAR.

6. The apparatus of claim 1, wherein the at least one processor is further configured to transmit, to the base station, at least one retransmission of the Msg3 PUSCH using the waveform indicated for an initial transmission of the Msg3 PUSCH.

7. The apparatus of claim 1, wherein the at least one processor is further configured to transmit, to the base station, at least one retransmission of the Msg3 PUSCH using another waveform different from the waveform indicated for an initial transmission of the Msg3 PUSCH.

8. The apparatus of claim 1, wherein the at least one processor is further configured to:
receive, from the base station, a hybrid automatic repeat request (HARQ) response based on the Msg3 PUSCH transmitted to the base station, the HARQ response indicating a retransmission waveform; and
transmit, to the base station, at least one retransmission of the Msg3 PUSCH using the retransmission waveform based on the HARQ response received from the base station.

9. The apparatus of claim 8, wherein the retransmission waveform is indicated in a reserved bit of downlink control information (DCI) associated with the HARQ response.

10. The apparatus of claim 1, wherein the Msg1 indicates support for waveform switching for the Msg3 PUSCH.

11. The apparatus of claim 10, wherein the Msg1 indicates the support for the waveform switching based on at least one of:
a random access channel (RACH) occasion of the Msg1,
a RACH preamble comprised in the Msg1, or
an indication of another capability.

12. The apparatus of claim 1, further comprising a transceiver coupled to the at least one processor, and wherein the waveform comprises cyclic prefix orthogonal frequency division multiplexing (CP-OFDM) or discrete Fourier transform spread orthogonal frequency division multiplexing (DFT-S-OFDM).

13. An apparatus for wireless communication at a network node, comprising:
a memory; and
at least one processor coupled to the memory and configured to:
receive a first random access message (Msg1);
output for transmission, for a user equipment (UE), an indication of a waveform of a third random access message (Msg3) physical uplink shared channel (PUSCH); and
receive the Msg3 PUSCH using the waveform indicated to the UE.

14. The apparatus of claim 13, wherein the indication of the waveform for the Msg3 PUSCH is in a downlink control information (DCI) associated with a random access response (RAR) in a second random access message (Msg2).

15. The apparatus of claim 13, wherein the indication of the waveform for the Msg3 PUSCH is in a random access response (RAR) to the Msg1.

16. The apparatus of claim 15, wherein the indication of the waveform for the Msg3 PUSCH is in at least one of a first bit of a medium access control (MAC) protocol data unit (PDU) of the RAR or a second bit of a MAC payload of the RAR.

17. The apparatus of claim 15, wherein the indication of the waveform for the Msg3 PUSCH is in a channel state information (CSI) request field of an uplink grant in the RAR.

18. The apparatus of claim 13, wherein the at least one processor is further configured to receive at least one retransmission of the Msg3 PUSCH using the waveform indicated for an initial transmission of the Msg3 PUSCH.

19. The apparatus of claim 13, wherein the at least one processor is further configured to receive at least one retransmission of the Msg3 PUSCH using another waveform different from the waveform indicated for an initial transmission of the Msg3 PUSCH.

20. The apparatus of claim 13, wherein the at least one processor is further configured to:
output for transmission, for the UE, a hybrid automatic repeat request (HARQ) response based on the Msg3 PUSCH received, the HARQ response indicating a retransmission waveform; and
receive at least one retransmission of the Msg3 PUSCH using the retransmission waveform based on the HARQ response transmitted for the UE.

21. The apparatus of claim 20, wherein the retransmission waveform is indicated in a reserved bit of downlink control information (DCI) associated with the HARQ response.

22. The apparatus of claim 13, wherein the Msg1 indicates support for waveform switching for the Msg3 PUSCH, and the indication of the waveform of the Msg3 PUSCH is output based on the support for waveform switching for the Msg3 PUSCH received.

23. The apparatus of claim 22, wherein the Msg1 indicates the support for the waveform switching based on at least one of:
a random access channel (RACH) occasion of the Msg1,
a RACH preamble comprised in the Msg1, or
an indication of another capability.

24. The apparatus of claim 13, further comprising a transceiver coupled to the at least one processor, and wherein the waveform comprises cyclic prefix orthogonal frequency division multiplexing (CP-OFDM) or discrete Fourier transform spread orthogonal frequency division multiplexing (DFT-S-OFDM).

25. A method of wireless communication of a user equipment (UE), comprising:
transmitting, to a base station, a first random access message (Msg1);
receiving, from the base station, an indication of a waveform of a third random access message (Msg3) physical uplink shared channel (PUSCH); and
transmitting, to the base station, the Msg3 PUSCH using the waveform indicated by the base station.

26. The method of claim 25, further comprising:
transmitting, to the base station, at least one retransmission of the Msg3 PUSCH using the waveform indicated for an initial transmission of the Msg3 PUSCH.

27. The method of claim 25, further comprising:
receiving, from the base station, a hybrid automatic repeat request (HARQ) response based on the Msg3 PUSCH transmitted to the base station, the HARQ response indicating a retransmission waveform; and
transmitting, to the base station, at least one retransmission of the Msg3 PUSCH using the retransmission waveform based on the HARQ response received from the base station.

28. A method of wireless communication of a network node, comprising:
receiving a first random access message (Msg1);
outputting for transmission, for a user equipment (UE), an indication of a waveform of a third random access message (Msg3) physical uplink shared channel (PUSCH); and
receiving the Msg3 PUSCH using the waveform indicated to the UE.

29. The method of claim 28, further comprising:
receiving at least one retransmission of the Msg3 PUSCH using the waveform indicated for an initial transmission of the Msg3 PUSCH.

30. The method of claim 28, further comprising:
outputting for transmission, for the UE, a hybrid automatic repeat request (HARQ) response based on the Msg3 PUSCH received, the HARQ response indicating a retransmission waveform; and
receiving at least one retransmission of the Msg3 PUSCH using the retransmission waveform based on the HARQ response transmitted for the UE.
